(19) United States
(12) Patent Application Publication
(10) Pub. No.: US 2007/0225999 A1
(43) Pub. Date: Sep. 27, 2007

(54) COMMERCE EXCHANGE SYSTEM

(75) Inventors: A. Leigh Powell, Moorestown, NJ (US); Mark Tilly, Scarborough, ME (US)

Correspondence Address: JACOBS & KIM LLP, 1050 WINTER STREET, SUITE 1000, #1082, WALTHAM, MA, 02451-1401, US

(73) Assignee: I-Many, Inc., Portland, ME (US)

(21) Appl. No.: 11/685,959

(22) Filed: Mar. 14, 2007

Related U.S. Application Data
(63) Continuation of application No. 09/899,357, filed on Jul. 5, 2001.
(60) Provisional application No. 60/216,913, filed on Jul. 6, 2000.

(51) Int. Cl. G06Q 30/00

(52) U.S. Cl. 705/1

(57) ABSTRACT

A commerce exchange system manages contracts between manufacturers, distributors, and purchasers, and is accessible by all of the contracting parties over the Internet. Group purchasing organizations can access the system to place orders for distribution to various end users. The system stores data representing information regarding all of the parties in the contracting process. The system also stores data describing all of the products and services available from the seller, including dates of availability, sizes, prices, and other such information. The system also stores and updates all of the contract terms, product shipments, payments made, rebates due and chargeback payments.

### CROSS-REFERENCE TO RELATED APPLICATIONS; INCORPORATION BY REFERENCE

This application for U.S. patent is a Continuation of pending U.S. patent application Ser. No. 09/899,357 filed Jul. 5, 2001, which claims the priority benefit of U.S. provisional application for patent 60/216,913 filed Jul. 6, 2000, each of which is which is incorporated by reference herein in its entirety.

### FIELD OF THE INVENTION

The present invention relates to a method and system for managing commerce, and in particular, relates to a system for industry-wide processing of contracts, including purchasing, payments, shipments, discounts and rebates.

### BACKGROUND OF THE INVENTION

A business such as a hospital or a restaurant purchases goods and supplies from several different manufacturers, and through a variety of distributors. Currently, purchasers find it difficult to monitor various aspects of the exchange, such as negotiating a contract given the variety of prices, dates of delivery, products available from different manufacturers. In addition the purchaser must then track when shipments have been received, when payments are due and have been made, whether a rebate is due from a manufacturer, and other such information. Customers who make payments by mail to a manufacturer or distributor must wait for different systems to be updated before their payment is recognized.

Distributors must manage shipments received from manufacturers, shipments made to purchasers, and must track payments made based on shipments. Distributors also must track when chargeback payments are made to them from manufacturers.

Manufacturers must distribute their products and prices to a large number of purchasers, and have difficulty in maintaining product offerings. Manufacturers must track purchase made from users, shipments made to distributors or directly to the user, and must track payments received. The manufacturer may provide individual rebates directly to the end user based on the amount of a product purchased, and may pay chargeback payments based on validated customer shipments to the distributor. All of these functions are time-consuming and difficult to keep up to date and accurate.

In addition, an industry may use a group purchasing organization to purchase supplies in order to reduce costs. There is a need, therefore, for a system that manages contracts and transactions between a variety of entities in an industry, including purchasers, group purchasing organizations, distributors, and manufacturers.

It is therefore desirable to provide purchasers with a system to order products at contracted prices, to validate shipment data or to negotiate disputes with manufacturers or distributors, and to make payments for purchased products.

It is also desirable to provide manufacturers a system to post products and prices, to negotiate contracts, track shipments, calculate rebates due to the purchaser, pay chargeback payments to the distributor, and to accept payments for goods purchased.

It is further desirable to provide distributors with a system to track orders and shipments, to receive payments, to have disputes arbitrated.

It is also desirable to allow group purchasing organizations to purchase goods through the system, and track purchases, contracts, shipments and prices.

### SUMMARY OF THE INVENTION

The present invention provides a system for managing contracts that is accessible by all of the contracting parties over the Internet. The system stores data representing information regarding all of the parties in the contracting process, including the sellers, the distributors and the purchasers. In addition, group purchasing organizations can access the system to place orders for distribution to various end users. The system also stores data describing all of the products and services available from the seller, including dates of availability, sizes, prices, and other such information. When a buyer accesses the system and negotiates a contract with a seller, the contract is validated and stored in the system. The system then tracks any shipments of the product that are made from the distributor to the purchaser. Payments are made electronically through the system, and the system determines when rebates are due to the purchaser from the seller, according to the terms of the contract, and makes chargeback payments to the distributor.

### BRIEF DESCRIPTION OF THE DRAWINGS

Various aspects and embodiments of the present invention are set forth in the attached drawing figures, in which:

FIG. 1 is a diagram of the contract commerce processing exchange system of the present invention is shown as it relates to the food service industry;

FIG. 2 illustrates how the manufacturers, purchasers, and distributors of FIG. 1 access the Contract Commerce Processing Exchange System of the present invention using the Internet;

FIG. 3 is a diagram of the contract commerce processing exchange system of the present invention is shown as it relates to the healthcare industry;

FIG. 4 illustrates how the manufacturers, distributors, group purchasing organizations and health care providers of FIG. 3 access the Contract Commerce Processing Exchange System of the present invention; and

FIG. 5 is a system diagram showing the Contract Commerce Processing Exchange System of the present invention in greater detail.

### DETAILED DESCRIPTION OF THE INVENTION

The system of the present invention provides contract processing for many different types of industries. The system manages the contract terms between entities, determines eligibility, pricing, dates of delivery, and available products between manufacturers, distributors, and end users. The manufacturers may provide individual rebates directly to the end user. The system also validates shipment data and negotiates disputes between the distributor and the manufacturer or end user, and determines deviated billing payments based on validated customer shipments. The system sends shipment data to the parties in a variety of formats, including paper, disk, electronic spreadsheet, or Electronic Data Interchange (EDI) format. The contract terms, such as type of product and price, may also be entered in variety of formats, including by fax, telephone, mail, or electronically.

The system will be described using the following two examples, the food service industry and the health care industry, although it will be apparent that the system can be used in many other industries.

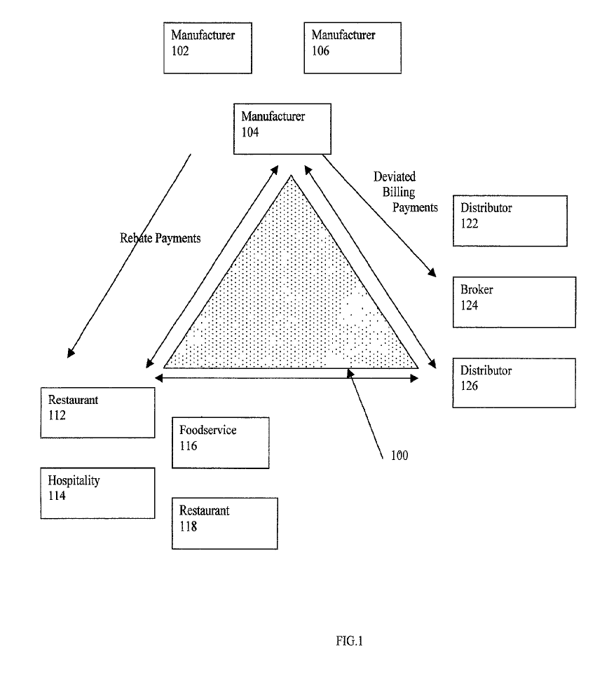

Referring to FIG. 1, a diagram of the contract commerce processing exchange system of the present invention is shown as it relates to the food service industry. Sellers of goods, here manufacturers 102, 104, 106 provide goods to the purchaser, which in this case is the restaurant, hospitality and other foodservice firms 112, 114, 116, 118, either directly, or through distributors and brokers 122, 124, 126. The system of the present invention manages contract terms, eligibility, pricing, dates and products by fax, mail or telephone between the manufacturer and the restaurant, the manufacturer and the distributor, and the distributor and the restaurant. The manufacturers may provide individual rebate payments for each chain or entity. In addition, the distributor can receive chargeback payments based on validated customer shipments.

In addition, the system sends shipment data in paper, disk, spreadsheet or EDI format, provides price books with contracted pricing, allows purchasers to order products at contracted prices, validates shipment data and negotiates disputes between the various parties.

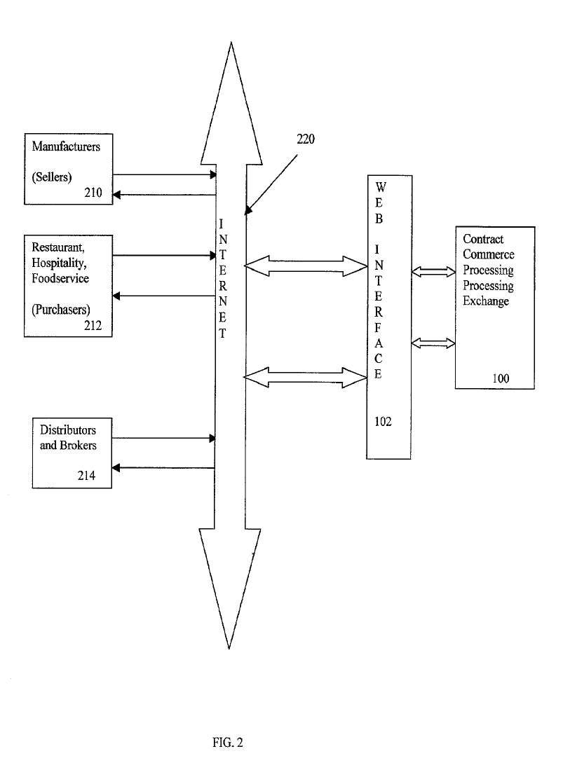

As shown in FIG. 2, manufacturers 210, purchasers 212 such as restaurants, hospitality and other foodservice entities, and distributors 214 connect to the Internet 220 to access the Contract Commerce Processing Exchange System 100 of the present invention, which interfaces with the Internet using XML and Web Browser Internet Interface 102.

The manufacturers 210 access the system 100 to update contracts, products, prices, timeframes and eligibility. They can also manage exceptions, authorize payments, respond to communications from trading partners, review current status of contracts, information and reports. The manufacturers 210 can also receive information from the Processing Exchange system 100. Manufacturers 210 can receive Electronic Fund Transfer (EFT) payment requests, receive customer shipment data, and receive communications from trading partners.

The purchasers 212, in this case restaurants and other food-services entities, send data to the Processing Exchange system 100 over the Internet. These include communications with trading partners, such as purchase orders. The purchaser can also review contract terms and pricing, view contract performance, view accrued rebates and trade funds. The purchaser receives data from the Processing Exchange system 100, including EFT payments and trading partner communications. The restaurant can also integrate contract pricing into purchasing systems.

Distributors 214, access the system to submit customer shipments, review contract terms and pricing, view contract performance, view accrued rebates, receive EFT payments, and integrate contact pricing into order entry systems. The distributor can also send and receive communications with trading partners.

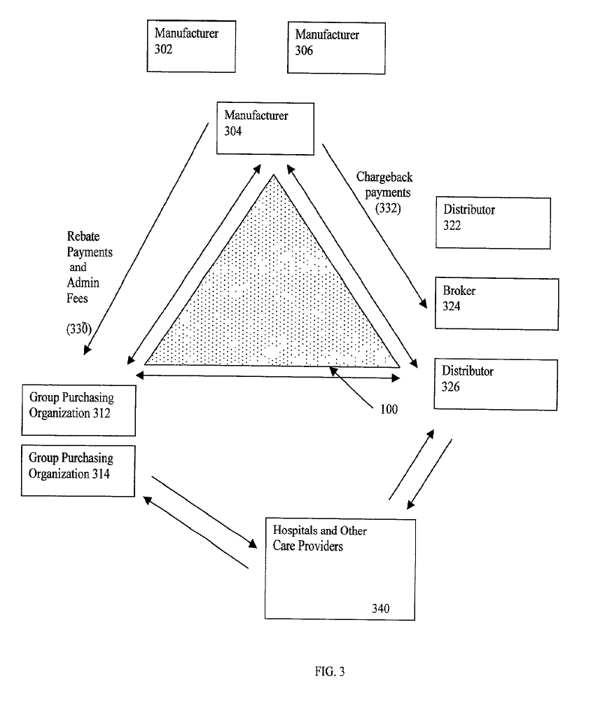

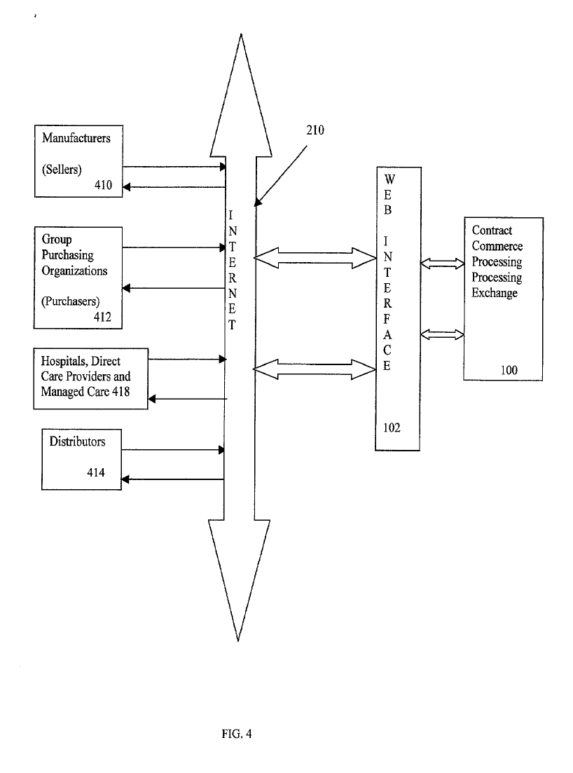

Referring to FIGS. 3 and 4, the present invention can similarly be used in the healthcare industry. In this case, hospitals and other health care providers 340 purchase healthcare items through group purchasing organizations 312 and 314. The Processing Exchange system 100 is accessed by the purchasing organization to manage the purchases. It is similarly accessed by the manufacturers 302, 304, 306 and distributors 322, 326 and 328. Chargeback payments are made from a manufacturer to the distributor based on validated customer shipments. Administration fees and rebate payments are made from the manufacturer to the group purchasing organization. The group purchasing organization can then pay performance-based rebates to members. In addition, the Processing Exchange system 100 notifies the hospitals and other care providers 340 of any contract pricing that was negotiated by the group purchasing organization. The hospitals 340 can then order the products from the distributor at the contracted prices.

FIG. 4 shows how all of these parties access the Processing Exchange System 100 over the Internet 220. The manufacturers 414 update their products with the Processing Exchange system 100. The group purchasing organizations 412 can place orders into the system 100, which are forwarded onto the distributor 414, who submits customer shipments into the system, and orders wholesale from the manufacturer. All payments may be made using EFT payments through the system. The group purchasing organization can view contract performance and can view accrued rebates and administration fees using the system 100. The system collaborates on processing exceptions with the trading entities, and collaborates on eligibility and disputed chargebacks. The system 100 is used for communications between the parties.

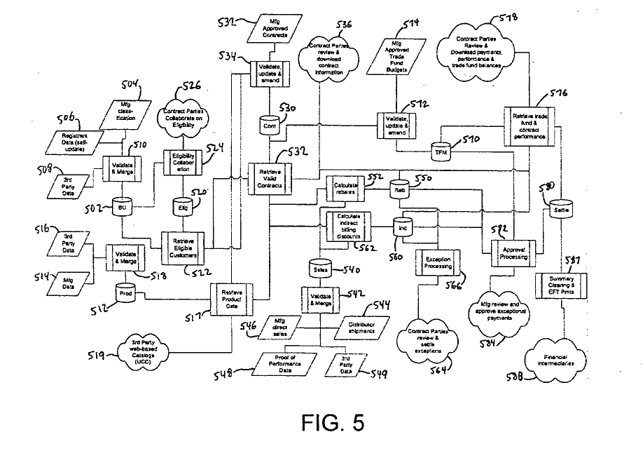

FIG. 5 shows the Processing Exchange System 100 in greater detail. The BU Data Store 502 contains detailed description data on all of the entities in the contracting process for an industry. This data includes names, addresses, contacts, identifying numbers, customer hierarchies, phone, fax, and e-mail addresses and relevant dates. Additionally the system accesses the BU Data Store to provide multiple views of the end customers for each manufacturer and distributor. The system obtains the entity data from manufacturing classifications 504, registrant data 506, and third party data 508. The system validates and merges this information at 510, and stores the data in the BU data store 502.

The system stores product data in the Product Data Store 512. The system obtains the product data from data obtained from the manufacturers 514 and from other third parties 516. This data is validated and merged at 518 before being stored in the Product data store 512. The Product Data Store 512 contains descriptive information on all products and services utilized in the contracting process, including names, identifying numbers, descriptions, product hierarchies, packaging, sizes and relevant dates. Product data is also retrieved (517) from third party web-based catalogs (519), and other information available over the Internet.

The Eligibility Data Store 520 contains lists of entities that are eligible to participate on contracts, as well as valid dates of eligibility and historical amendment information. Collaboration processes are supported with working storage for collaborating partners. The eligible entities are determined by retrieving eligible customers (522) from the BU Data Store 502. The contracting parties collaborate on the eligibility of the entities (526), and provide the eligibility collaboration (524) to the Eligibility Data Store 520.

The Contract Data Store 530 contains information describing each contract in the system. The information includes contract parties, products, pricing arrangements, pricing tiers, contract dates and terms, conditional terms, status and a history of amendments. The Contract Data Store 530 obtains contracts as approved by manufacturers (532), and validates, updates and amends the contracts as changes occur (534). The system retrieves valid contracts (532) from the Contract Data Store 530, and provides needed information to other functions of the system. After contracting parties review and download contract information (536), the system retrieves the updated information for the valid contracts (532), which updates the Contract Data Store 530.

The Sales Data Store 540 contains sales and shipment data for each product and party on the contract. It also includes third party data such as market shares and performance information used to validate contract conditions. The system validates and merges (542) information received from distributors regarding shipments (544), from manufacturers regarding direct sales (546), from proof of performance data (548) and third-party data (549).

The Rebate Data Store 550 contains calculated rebates based on contract terms. The information stored includes sales, performance conditions met, product and customer and calculated rebate amounts. Errors and warnings are identified with codes. The system calculates rebates (552) from product data (517) and contract data (532), and stores the rebate data in the Rebate Data Store 550. Dated status reports and amendment processing control the workflow of this data store, and the Indirect Discount Data Store 560.

The Indirect Discount Data Store 560 contains calculated indirect discounts to distributors and brokers based on their customer shipments and the contract terms. The information stored includes shipments, product, customer, dates and calculated discount amounts. Errors and warnings are identified with codes. After contracting parties review and settle exceptions (564), the system processes the exceptions and updates the Rebate Data Store 550 and the Indirect Discount Data Store 560.

The TFM data store 570 contains budgeted and actual trade funds balances by customer and product line for a manufacturer or other contract-writing party. As rebates and discounts are processed, customer trade fund balances are updated. In addition, rules on the use of trade funds are stored, as well as dated status and amendments. The system validates, updates and amends (572) manufacturer's approved trade fund budgets 574. The system also retrieves trade fund and contract performance (576) information when contracting parties review and download payments, performance and trade fund balances (578).

The Settle Data Store 580 contains information on payments due for rebate and indirect discounts. Information includes payee, payment methods, amounts, dates, status and amendments. The system processes approvals (582) after manufacturers review and approve exceptional payments (584).

The Commerce Exchange System of the present invention thus manages contracts between all of the contracting entities, and is available to every type of industry. The system is accessed over the Internet, and allows orders to be placed, tracked and paid for over Internet.

1-20. (canceled)

21. A system for managing commerce comprising:
an interface for sending and receiving data to and from the Internet;
means for storing data representative of a manufacturer of a product, a distributor and a purchaser in a commercial arrangement of at least three entities comprising manufacturer, distributor and purchaser, the means for storing data representative of a manufacturer, a distributor and a purchaser comprising means for storing data representative of contractual relationships between a manufacturer, a distributor and a purchaser in a commercial arrangement of at least three entities comprising manufacturer, distributor and purchaser,
means for storing data representative of a product available from the manufacturer;
means for storing data representative of a contract between the manufacturer and the purchaser;
means for storing data representative of a purchase of the product by the purchaser from the manufacturer;
means for storing data representative of a shipment of the product from the distributor to the purchaser;
means for determining a rebate due to the purchaser from the manufacturer
means for transferring a payment, for goods purchased, received from the purchaser to the manufacturer at least in part via the Internet; and
means for determining a chargeback payment due from the manufacturer to the distributor, and for storing chargeback data representative of chargeback payments therebetween, wherein the manufacturer, the distributor and the purchaser access the system using the Internet and wherein chargeback data are available to both manufacturer and distributor.

22. The system of claim 21 wherein data representative of a contract comprises at least two party names, a product, a price, a date, and a term.

23. The system of claim 22 wherein data representative of a contract further comprises a rebate due from the manufacturer to the purchaser.

24. The system of claim 21 further comprising:
means for determining a trade fund balance for each product purchased by the purchaser from the manufacturer; and means for updating the trade fund balance when a rebate is processed.

25. The system of claim 21 wherein the trade fund balance further comprises an actual trade fund balance and a budgeted trade fund balance.

26. A system for managing commerce comprising:
an interface for sending and receiving data to and from the Internet;
means for storing data representative of a manufacturer of a product, a distributor, a group purchasing organization and an end user in a commercial arrangement comprising at least four entities, the means for storing data representative of a manufacturer, a distributor, a group purchasing organization and an end user comprising means for storing data representative of contractual relationships therebetween;
means for storing data representative of a product available from the manufacturer;
means for storing data representative of a contract between the manufacturer and the group purchasing organization;
means for storing data representative of a purchase of the product by the group purchasing organization from the manufacturer;
means for storing data representative of a shipment of the product from the distributor to the end user;
means for determining a rebate due to the group purchasing organization from the manufacturer;
means for transferring a payment, for goods purchased, received from the group purchasing organization to the manufacturer at least in part via the Internet;
wherein the manufacturer, the distributor and the group purchasing organization access the system using the Internet.

27. The system of claim 26 wherein data representative of a contract comprises at least two party names, a product, a price, a date, and a term.

28. The system of claim 27 wherein data representative of a contract further comprises a rebate due from the manufacturer to the group purchasing organization.

29. The system of claim 26 further comprising:
means for determining a trade fund balance for each product purchased by the group purchasing organization from the manufacturer; and means for updating the trade fund balance when a rebate is processed.

30. The system of claim 26 wherein the trade fund balance further comprises an actual trade find balance and a budgeted trade fund balance.

31. A method for managing commerce from an electronic commerce site accessed over a network, comprising:
storing data representative of a manufacturer of a product, a distributor and a purchaser in a commercial arrangement of at least three entities comprising manufacturer, distributor and purchaser, the storing including storing data representative of contractual relationships between a manufacturer, a distributor and a purchaser;
storing data representative of a product available from the manufacturer;
storing data representative of a contract between the manufacturer and the purchaser;
storing data representative of a purchase of the product by the purchaser from the manufacturer;
storing data representative of a shipment of the product from the distributor to the purchaser;
determining a rebate due to the purchaser from the manufacturer;
transferring a payment, for goods purchased, received from the purchaser to the manufacturer at least in part via the network; and
determining a chargeback payment due from the manufacturer to the distributor, and storing chargeback data representative of chargeback payments therebetween, and wherein chargeback data are available to both manufacturer and distributor.

32. The method of claim 31 wherein data representative of a contract comprises at least two party names, a product, a price, a date, and a term.

33. The method of claim 32 wherein data representative of a contract further comprises a rebate due from the manufacturer to the purchaser.

34. The method of claim 31 further comprising:
determining a trade fund balance for each product purchased by the purchaser from the manufacturer; and updating the trade fund balance when a rebate is processed.

35. The method of claim 31 wherein the trade fund balance further comprises an actual trade fund balance and a budgeted trade fund balance.

36. A method for managing commerce from an electronic commerce site accessed over a network, the method comprising:
storing data representative of a manufacturer of a product, a distributor, a group purchasing organization and an end user in a commercial arrangement comprising at least four entities, including storing data representative of contractual relationships therebetween;
storing data representative of a product available from the manufacturer;
storing data representative of a contract between the manufacturer and the group purchasing organization;
storing data representative of a purchase of the product by the group purchasing organization from the manufacturer;
storing data representative of a shipment of the product from the distributor to the end user; determining a rebate due to the group purchasing organization from the manufacturer; and
transferring a payment, for goods purchased, received from the group purchasing organization to the manufacturer, at least in part via the network.

37. The method of claim 36 wherein data representative of a contract comprises at least two party names, a product, a price, a date, and a term.

38. The method of claim 37 wherein data representative of a contract further comprises a rebate due from the manufacturer to the group purchasing organization.

39. The system of claim 36 further comprising:
determining a trade find balance for each product purchased by the group purchasing organization from the manufacturer; and updating the trade fund balance when a rebate is processed.

40. The method of claim 36 wherein the trade fund balance further comprises an actual trade fund balance and a budgeted trade fund balance.
